(19) United States
(12) Patent Application Publication
(10) Pub. No.: US 2010/0260580 A1
(43) Pub. Date: Oct. 14, 2010

(54) LOCKING ELEMENT AND BOLTED JOINT

(75) Inventor: Mattias Andersson, Ostersund (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: NORD-LOCK AB, Mattmar (SE)

(21) Appl. No.: 12/680,588

(22) PCT Filed: Oct. 3, 2008
(86) PCT No.: PCT/SE08/51125

§ 371 Date: Mar. 29, 2010

(30) Foreign Application Priority Data
Oct. 4, 2007 (SE) 0702239-5

(51) Int. Cl. F16B 43/00

(52) U.S. Cl. 411/534

(57) ABSTRACT

A locking element for locking in a bolted joint, the locking element comprising one side comprising a pattern of radially extending cams, the main surface of which having a helix configuration, the pitch of the cams exceeding the pitch of the threads involved in the bolted joint. The locking element is especially characterized in that the locking element is a washer intended to be applied as a single locking element in the joint and in that the other, the opposite, side of the washer comprises mechanical means for providing a locking action for preventing rotation between said other side and a surface against which said other side is intended to act. The invention also relates to a bolted joint.

### BACKGROUND

1. Technical Field

The present invention relates to a locking element according to the introductory part of the attached claim 1.

The invention also relates to a bolted joint according to the attached claim 9.

2. Prior Art

Washers for locking purposes in bolted joints are previously known and normally comprises a central hole for a bolt element, one side with a pattern of radially extending teeth and the other side with a pattern of radially extending cams. The washers are used in pairs, the cam pattern surfaces facing each other, and the cam pitch exceeding the pitch of the bolt element threads, which causes a locking effect against untightening of the bolted joint.

The fact that a pair of washers are necessary for locking causes comparatively complicated mounting of the joint. Further, forming of the different patterns necessitates different dies etc. Furthermore, the washer cost of a bolted joint is considerable.

The object of the present invention is to provide a solution to these prior art problems.

### SUMMARY OF THE INVENTION

This object is obtained by a locking element and a bolted joint showing the features according to claims 1 and 9, respectively.

Further advantages are obtained by what is specified in the respective dependent claims.

### SHORT DESCRIPTION OF THE DRAWINGS

A better understanding of the present invention will be had based upon the following description of examples and preferred embodiments when read in conjunction with the attached drawings, in which:

FIG. 1 schematically shows a perspective view over a first embodiment of a washer according to the present invention;

FIGS. 2(a) and (b) schematically shows a bolted joint with a locking washer according to the present invention, as prior to tightening and as tightened, respectively;

FIG. 3 schematically shows the bolted joint of FIG. 2 as released, an impression having been made by the pattern of the washer;

FIG. 4 schematically shows a perspective view of a second embodiment of a washer according to the present invention;

FIG. 5(a)-(c) schematically shows a perspective view and a side view and a bottom view, respectively, of a locking element according to the present invention in the form of, primarily, a nut;

FIG. 6 schematically shows the match between helixly configured cam surfaces of two objects, washers, in spite of mutual rotation; and

FIG. 7 schematically shows the mismatch between flat cam surfaces of two objects, washers, due to mutual rotation.

### DETAILED DESCRIPTION OF PREFERRED EMBODIMENTS

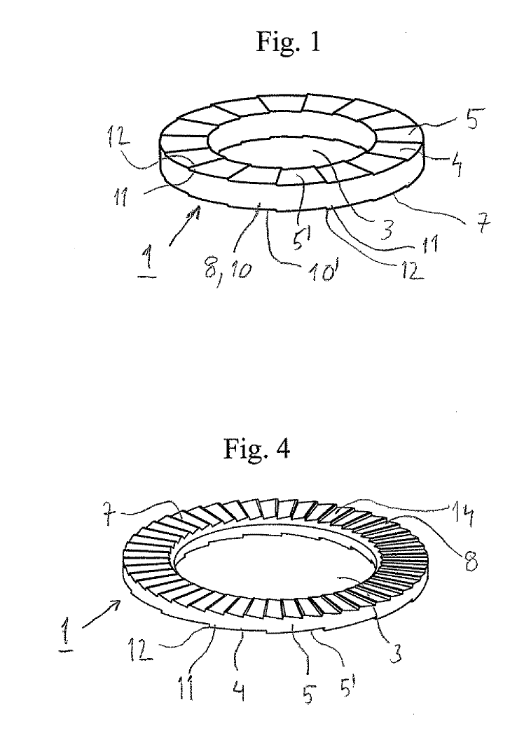

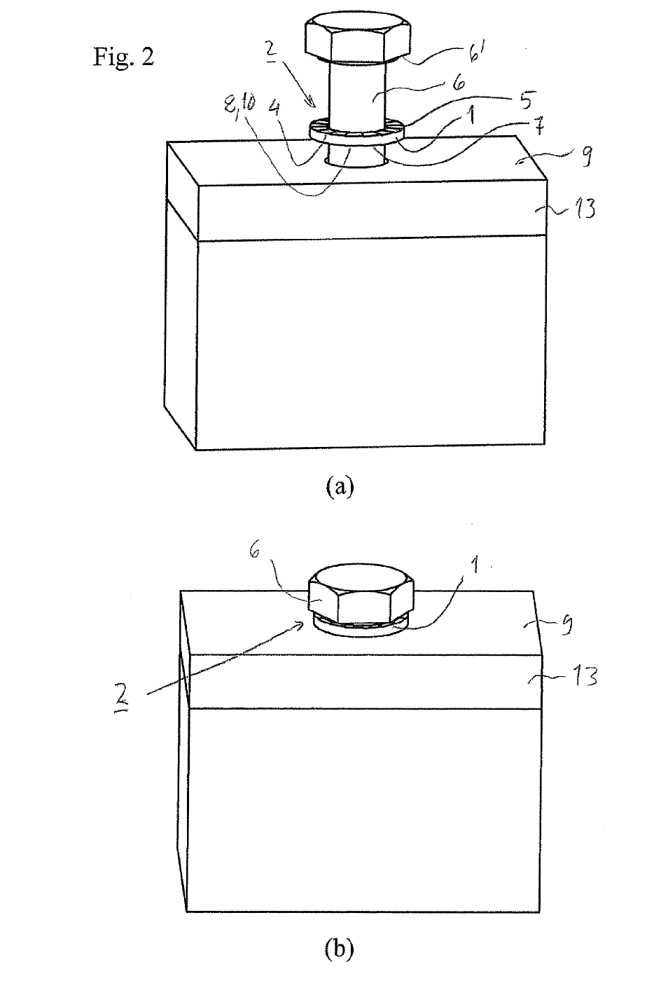

In FIG. 1, 1 designates a first embodiment of a locking washer according to the present invention the washer being intended for locking in a bolted joint 2, FIG. 2.

The washer comprises a central hole 3 and one side 4 comprising a pattern of radially extending cams 5, the main surface 5′ of which having a helix configuration, the pitch of the main surface exceeding the pitch of the threads of the bolt element 6, bolt or nut, that the washer is intended to lock.

Contrary to the normal use in pairs of locking washers of this kind, the washer according to the invention is intended to be applied as a single locking element in the joint as can be seen in eg FIG. 2(a).

The other, the opposite, side 7 of the washer comprises mechanical means 8 for preventing rotation between said other side and a surface 9, against which said other side is intended to act in the joint as tightened.

According to a preferred embodiment said mechanical means of said other side 7 comprises a pattern of radially extending cams 10, the main surface 10′ of which having a helix configuration, ie a pattern of substantially the same kind as the pattern of said one side 4, as schematically shown in FIG. 1.

Preferably the cams 5, 10 have a radially extending ridge 11 comprising a comparatively sharp edge 12 to promote penetration of the surface 6′, 9 upon which the cam acts in the joint as tightened.

According to preferred embodiments the washer material, preferably hardened steel, is harder than the material of the remaining parts of the bolted joint, ie eg an element 6, bolt or nut, and a work piece 13.

Also other kinds of mechanical means may be imagined.

Thus, according to one further embodiment said mechanical means 8 comprises a pattern of radially extending teeth 14, as schematically shown in FIG. 4. Preferably the teeth lie quite close to each other in the circumferential direction of the washer, the distance between adjacent teeth being not more than half the tooth width.

According to yet a further embodiment said mechanical means comprises pins, not shown, or other protruding elements arranged to co-operate with the surface 9, eg arranged to fit in pre-fabricated recesses, not shown, in said surface.

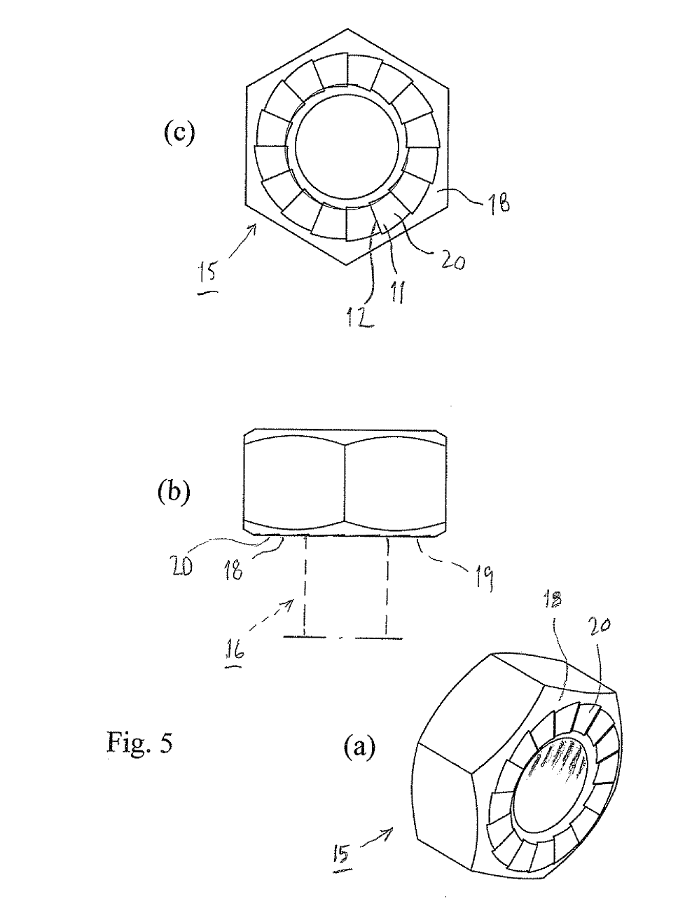

According to another aspect of the present invention, FIG. 5, the locking element is a nut 15 or a bolt 16, the bolt being schematically marked by dashed lines 17 in FIG. 5(b), one side 18 of the nut or the bottom side 19 of the bolt head, which sides 18, 19 are intended to interact with a surface 9 of a work piece 13 or the corresponding, are provided with a pattern of cams 20, ie a pattern of radially extending and helixly configured cams of the same kind as those of the washers described above.

Thus, in this case no washer at all is applied, the cam pattern being part of the nut or bolt locking element.

As is the case for the washers the cams 20 comprises a ridge 11 having a comparatively sharp edge 12.

The function of the locking element according to the present invention as well as of the bolted joint according to the invention should to a considerable and sufficient extent have been made clear from the description given above.

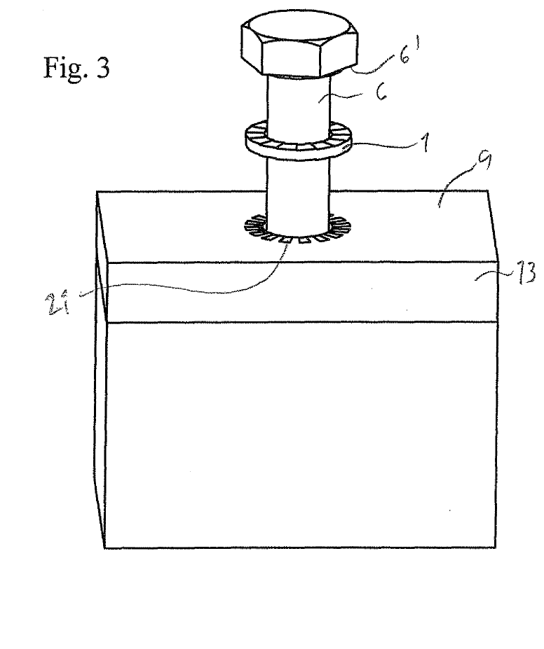

Thus, locking of a bolted joint is, according to one aspect of the present invention, performed by a single locking washer having at least one side comprising a pattern of cams, the other side comprising mechanical means for interaction with eg a work piece surface. When the joint is tightened both sides make impressions 21 by penetrating the surface, upon which the side pattern acts, as can be in FIG. 3. If said opposite side comprises protruding elements, eg pins, these are put in the corresponding recesses. Due to the helixly configured cams a large contact area is obtained. When the mechanical means 8 comprises a pattern of radially extending cams 10 corresponding to the cams 5 of said one side 4 and having a pitch exceeding the pitch of the threads of the bolted joint, the mechanical means will prevent rotation between said other side 7 and a surface 6′, 9, against which said other side is intended to act, by providing a locking action corresponding the locking action provided by the cam pattern of said one side, ie due to the pitch difference.

When untightening the joint, the bolt element, bolt or nut, having impressions made by the washer during tightening, slides against the washer cams. Alternatively the washer slides against the work piece or the corresponding having impressions 21 made by the washer during tightening The formation of the impressions is promoted by a sharp cam ridge edge and also by a washer hardness exceeding the hardness of the bolt element and the work piece or the corresponding, ie of the surface 6′, 9 interacting with the cams. The same goes for mechanical means in the form of eg teeth.

Further, according to other aspect of the present invention, locking of a bolted joint is performed by the bolt element, nut or bolt, itself also constituting a locking element by the pattern of cams 20 on one side interacting with the work piece or the corresponding. When the joint is tightened the cam 20 pattern side 18, 19 of the bolt element makes impressions 21 by penetrating the surface, upon which the side pattern acts in the same way as shown in FIG. 3.

When untightening the joint of the other aspect of the present invention, the cams of the bolt element, bolt or nut, at the same time being the locking element, together with the impressions made during tightening, slides against the impressions 21. As is the case for the washers the formation of the impressions 21 is promoted by a sharp cam ridge and also by a bolt element hardness exceeding the hardness of the work piece or the corresponding, ie of the surface 9 interacting with the cams.

Thus, due to the helixly configured cams, originally being part of a washer, a bolt head or a nut or being indentations 21 made by helixly configured cams of said mechanical means, an as large a contact area as possible is obtained in the contact between two objects having said helixly configured cams, the opposing helix cam surfaces centered in relation to the same axis, always match over the whole possible contact surface irrespective of the angle of mutual rotation between the two objects. In this way a safe cam locking effect is obtained also when using locking elements according to the present invention.

In case of non-helixly cams, ie flat cam surfaces, two objects having flat cam surfaces only match perfectly in a single position of mutual rotation. Thus, locking elements having flat cam surfaces provide a very small contact surface, high contact pressure and high friction force between the objects at mutual rotation, which means that a safe cam locking effect is not obtained but merely a friction locking.

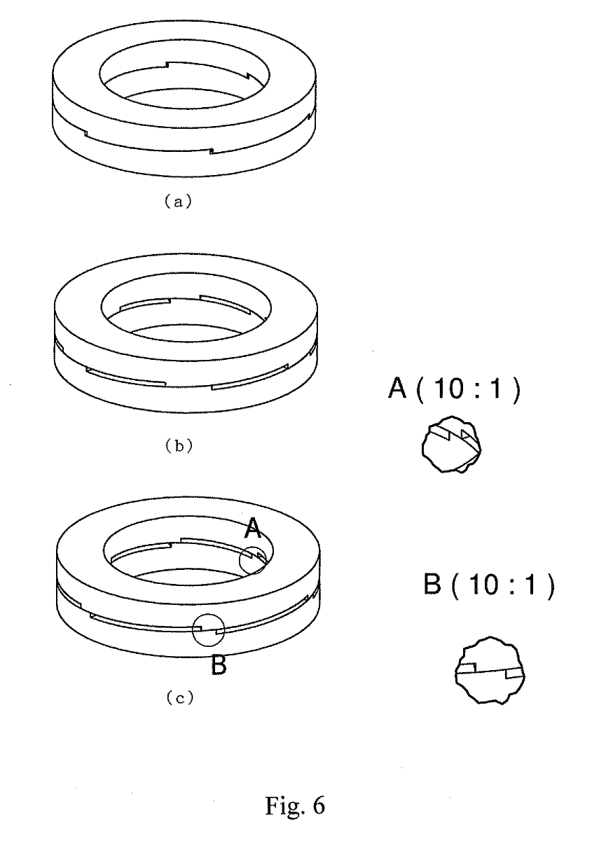

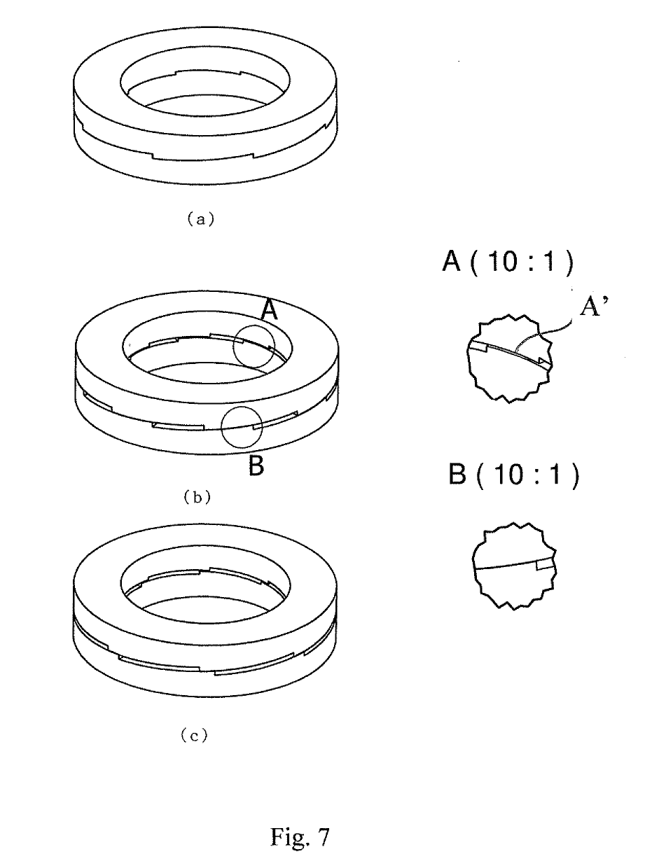

The difference in function between helixly configured cam surfaces and flat cam surfaces is illustrated in FIGS. 6 and 7.

In FIG. 6(a) and FIG. 7(a) a match is at hand. In FIG. 6(b) and (c) a match is still at hand in spite of mutual rotation as ca be seen at both A and B. In FIGS. 7(b) and (c) representing mutual rotation a match is at hand only at the outer periphery as can be seen at B but not at substantially the rest of the contact surface as can be seen at A where a gap A′ exists between the objects.

Above, the invention has been described in conjunction with examples and preferred embodiments.

Of course, further embodiments and minor changes and additions may be imagined without departing from the basic inventive idea.

Thus, of course the washer according to the invention may be turned so that the mechanical means 8 act upon the bolt element, eg the bottom side 6′ of a bolt.

Further, in case of mechanical means 8 in the form of pins or other protruding elements, these may be arranged on the surface against which the locking element is intended to act. In such a case the mechanical means of the locking element will be eg pre-fabricated recesses in which the protruding elements are intended to fit.

Furthermore, in case of mechanical means in the form of pins etc, the locking element does not need to be harder than the surface together with which the locking element is intended to act, since mechanical means, pins etc and recesses, preferably are pre-formed.

As far as the locking elements, washers, bolts, nuts etc are concerned, these are preferably of hardenable steel and the element hardness is preferably ≧465 HV.

Thus, the present invention should not be considered limited to the embodiments shown but may be varied within the scope of the attached claims.

1. A locking element for locking in a bolted joint, the locking element comprising one side comprising a pattern of radially extending cams, the main surface of which having a helix configuration, the pitch of the cams exceeding the pitch of the threads involved in the bolted joint, wherein the locking element is a washer intended to be applied as a single locking element in the joint and in that the other, the opposite, side of the washer comprises mechanical means for providing a locking action for preventing rotation between said other side and a surface against which said other side is intended to act.

2. A locking element according to claim 1, wherein said mechanical means comprises a pattern of radially extending cams, the main surface of which having a helix configuration.

3. A locking element according to claim 1, wherein said mechanical means comprises a pattern of radially extending teeth.

4. A locking element according to claim 3, wherein the distance between said teeth in the circumferential direction is small and not more than half the tooth width.

5. A locking element according to claim 1, wherein said mechanical means are pins or other similar protruding elements arranged co-operate with, preferably pre-fabricated, recesses in said surface or, preferably pre-fabricated, recesses for co-operating with pins or other similar protruding elements of said surface.

6. A locking element for locking in a bolted joint, the locking element comprising one side comprising a pattern of radially extending cams, the main surface of which having a helix configuration, the pitch of the cams exceeding the pitch of the threads involved in the bolted joint, wherein the locking element is a nut or a bolt, the side comprising the pattern of cams being the side intended to interact with a surface of a work piece or the corresponding.

7. A locking element according to claim 1, wherein the cams have a radially running ridge comprising a comparatively sharp edge.

8. A locking element according to claim 1, wherein the locking element material, preferably hardened steel, is harder than the material of the remaining parts of the bolted joint.

9. A bolted joint, comprising a locking element according to claim 1.

10. A bolted joint according to claim 9, wherein said locking element is a washer and said mechanical means are intended to act on a work-piece of the joint.
